(19) United States
(12) Patent Application Publication
(10) Pub. No.: US 2019/0147877 A1
(43) Pub. Date: May 16, 2019

(54) METHOD FOR ASSISTING HUMAN-COMPUTER INTERACTION AND COMPUTER-READABLE MEDIUM

(71) Applicant: BEIJING VRV SOFTWARE CORPORATION LIMITED, Beijing (CN)

(72) Inventors: Hao Lin, Beijing (CN); Li Zhong, Beijing (CN)

(73) Assignee: BEIJING VRV SOFTWARE CORPORATION LIMITED, Beijing (CN)

(21) Appl. No.: 16/243,303

(22) Filed: Jan. 9, 2019

Related U.S. Application Data
(63) Continuation-in-part of application No. PCT/CN2016/000512, filed on Sep. 7, 2016.

(30) Foreign Application Priority Data
Aug. 18, 2016 (CN) 201610682959.7

(51) Int. Cl. G10L 15/22; G06F 3/16; G06F 17/27; G10L 15/18

(52) U.S. Cl. CPC G10L 15/22; G06F 3/167; G10L 2015/223; G06F 17/2785; G10L 15/1822; G06F 17/2705

(57) ABSTRACT

A method for assisting human-computer interaction and a computer-readable medium applied to a human-computer interaction auxiliary device connected with an executing device. The method includes: acquiring a first control instruction, and the first control instruction includes a voice control instruction and/or a text control instruction parsing the first control instruction, generating a corresponding second control instruction according to the first control instruction, and the second control instruction is a preset control instruction that can be parsed by at least one of the executing device, and searching for, according to the first control instruction, a target executing device corresponding to the first control instruction and sending the second control instruction to the target executing device corresponding to the first control instruction.

### CROSS-REFERENCE TO RELATED APPLICATIONS

This application is a continuation-in-part application of International Patent Application No. PCT/CN2016/000512 filed on Sep. 7, 2016, which claims priority to Chinese Patent Application No. CN2016106829597 filed on Aug. 18, 2016, which is incorporated herein by reference in its entirety.

### TECHNICAL FIELD

The present disclosure relates to the field of information technology and the Internet of Things (IoT), and in particular to a method for assisting human-computer (man-machine) interaction and a computer-readable medium.

### BACKGROUND ART

With the rapid development of the mobile Internet, the Internet of Things, and the artificial intelligence technology, more and more intelligence executing devices have the function of receiving digitalized control information, and parsing instructions of users, by receiving information such as voice or text and the like sent by the users, so as to carry out corresponding actions.

At present, the executing device can only understand some control instructions of standard forms, and when the control instruction issued by the user is an instruction of a non-standard form (e.g., “It is kind hot, turn on the air conditioner at 26° C.”), or a voice instruction of a non-standard pronunciation (e.g., a voice instruction issued in a local dialect), the executing device will not be able to parse the instruction issued by the user, and cannot execute an action required by the user in time.

In the prior solutions, the user is alternatively required to issue an instruction of a standard form, so that it can be parsed by the executing device, thus, the user has to remember different instruction forms and use a standard pronunciation, which is very inconvenient in use, and reduces the user experience; or the device manufacturers are alternatively required to improve the intelligence level of the executing devices, and improve the capability of the executing devices to understand control instructions of non-standard forms, thus it is necessary to increase a large amount of capital investment to improve the executing devices.

Therefore, how to provide an economic and effective method to assist the executing device in parsing the control instruction issued by the user, has become an urgent problem to be solved by those skilled in the art.

### SUMMARY

In order to overcome the above-mentioned shortcomings in the prior art, the technical problem to be solved by the present disclosure is to provide a method for assisting human-computer interaction and a computer-readable medium, which are independent from an executing device and capable of assisting the executing device in parsing a control instruction issued by a user.

Regarding to the method, the present disclosure provides a method for assisting human-computer interaction, which is applied to a human-computer interaction assisting device connected to an executing device, the method comprises:

acquiring a first control instruction, wherein the first control instruction includes a voice control instruction and/or a text control instruction;

parsing the first control instruction;

generating a corresponding second control instruction based on the first control instruction, wherein the second control instruction is a preset control instruction that can be parsed by at least one of the executing devices;

searching for a target executing device corresponding to the first control instruction based on the first control instruction, and sending the second control instruction to the target executing device the first control instruction corresponding thereto.

The present disclosure further provides a method for assisting human-computer interaction, which is applied to an executing device and a human-computer interaction assisting device connected to each other, the method comprises:

acquiring a first control instruction by the human-computer interaction assisting device, wherein the first control instruction includes a voice control instruction or a text control instruction of a natural language form;

parsing the first control instruction;

generating a corresponding second control instruction based on the first control instruction, wherein the second control instruction is a preset control instruction that can be parsed by at least one of the executing devices; searching for a target executing device corresponding to the first control instruction based on the first control instruction, and sending the second control instruction to the target executing device the first control instruction corresponding thereto;

responding to the second control instruction, and executing an action corresponding to the second control instruction by the executing device.

The present application further provides a computer-readable medium having a processor-executable non-volatile program code, wherein the program code causes a processor to execute any one of the methods for assisting human-computer interaction described above.

Compared with the prior art, the present disclosure has the following beneficial effects:

In a method and apparatus for assisting human-computer interaction according to the present disclosure, a human-computer interaction assisting device, independent from the executing device, is disposed, such that the first control instruction that cannot be understood by the executing device is parsed by the human-computer interaction assisting device, and a second control instruction that can be understood by the executing device is generated and sent to the executing device. In this way, an effect of assisting the executing device in parsing an instruction issued by a user is achieved without increasing investment in improving an information receiving interface or intelligence level of the executing device. The method of the present disclosure is simple and easily feasible, effectively saves the cost, and improves the user experience.

### BRIEF DESCRIPTION OF DRAWINGS

In order to more clearly illustrate technical solutions of embodiments of the present disclosure, drawings required for use in the embodiments will be introduced briefly below, it is to be understood that the drawings below are merely illustrative of some embodiments of the present disclosure, and therefore should not be considered as limiting the scope of the disclosure, it would be understood by those of ordinary skill in the art that other relevant drawings could also be obtained from these drawings without any inventive effort.

FIG. 1 is a schematic diagram of an application environment according to an embodiment of the present disclosure;

FIG. 2 is a structural block diagram of a human-computer interaction assisting device according to an embodiment of the present disclosure;

FIG. 3 is a first schematic flowchart of a method for assisting human-computer interaction according to an embodiment of the present disclosure;

FIG. 4 is a first schematic flowchart of sub-steps of step S110 of the present disclosure;

FIG. 5 is a second schematic flowchart of sub-steps of the step S110 of the present disclosure;

FIG. 6 is a second schematic flowchart of a method for assisting human-computer interaction according to an embodiment of the present disclosure;

FIG. 7 is a schematic flowchart of sub-steps of step S140 of the present disclosure;

FIG. 8 is a third schematic flowchart of a method for assisting human-computer interaction according to an embodiment of the present disclosure;

FIG. 9 is a first schematic flowchart of sub-steps of step S210 of the present disclosure;

FIG. 10 is a second schematic flowchart of sub-steps of the step S210 of the present disclosure;

FIG. 11 is a fourth schematic flowchart of a method for assisting human-computer interaction according to an embodiment of the present disclosure; and

FIG. 12 is a structural block diagram of a human-computer interaction assisting apparatus according to an embodiment of the present disclosure.

Reference numerals in the above figures are corresponding to the following terms:

| | |
|---|---|
| Human-computer interaction assisting | 100 |
| device | |
| Human-computer interaction assisting | 110 |
| apparatus | |
| First control instruction acquisition module | 111 |
| Parsing module | 112 |
| Second control instruction generating | 113 |
| module | |
| Second control instruction sending | 114 |
| module | |
| Memory | 120 |
| Processor | 130 |
| Communication unit | 140 |
| Executing Device | 200 |
| Network | 300 |

### DETAILED DESCRIPTION OF EMBODIMENTS

In order to make the objects, technical solutions, and advantages of the embodiments of the present disclosure more clear, the technical solutions of the embodiments of the present disclosure will be described below clearly and completely with reference to the drawings of the embodiments of the present disclosure. It is apparent that the embodiments to be described are some, but not all of the embodiments of the present disclosure. Generally, the components of the embodiments of the present disclosure, as described and illustrated in the figures herein, may be arranged and designed in a wide variety of different configurations.

Thus, the following detailed description of the embodiments of the present disclosure, as represented in the figures, is not intended to limit the scope of the present disclosure as claimed, but is merely representative of selected embodiments of the present disclosure. All the other embodiments obtained by those of ordinary skill in the art in light of the embodiments of the present disclosure without inventive efforts would fall within the scope of the present disclosure as claimed.

It should be noted that similar reference numerals and letters refer to similar items in the following figures, and thus once an item is defined in one figure, it may not be further defined or explained in the following figures.

In the description of the present disclosure, it should be noted that terms such as “first”, “second”, and “third” are used for distinguishing the description, and should not be understood as an indication or implication of relative importance.

In the description of the present disclosure, it should also be noted that terms “provided”, “mounted”, “coupled”, and “connected” should be understood broadly unless otherwise expressly specified or defined. For example, connection may be fixed connection or detachable connection or integral connection, may be mechanical connection or electric connection, or may be direct coupling or indirect coupling via an intermediate medium or internal communication between two elements. The specific meanings of the above-mentioned terms in the present disclosure could be understood by those of ordinary skill in the art according to specific situations.

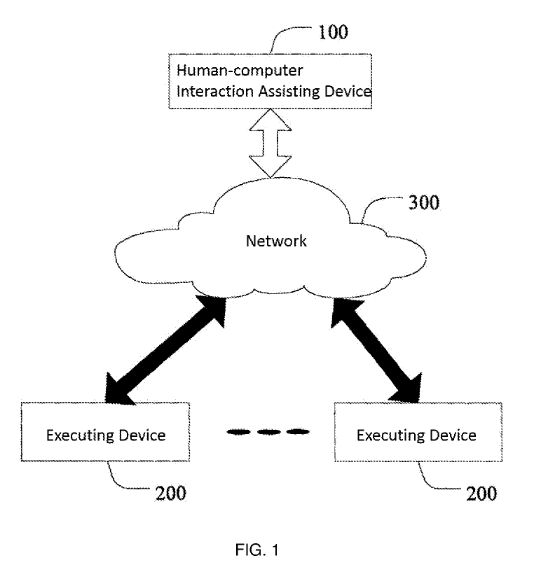

FIG. 1 shows a schematic diagram showing an interaction of communication between a human-computer interaction assisting device 100 and at least one executing device 200 according to a preferable embodiment of the present disclosure. The human-computer interaction assisting device 100 may communicate with the executing device 200 through a network 300, to implement data communication or interaction between the human-computer interaction assisting device 100 and the executing device 200. The network 300 may be, but is not limited to, a wired network or a wireless network. The network 300 may be, but is not limited to, a local area network or the Internet.

In the present application, the executing device 200 may be a smart home appliance, or may also be a smart household device, that is to say, the executing device 200 may be any device that can be controlled. The specific form of the executing device 200 is not specifically limited in the present application. The human-computer interaction assisting device 100 may be installed on the executing device 200 and communicatively connected thereto via a data communication line, or the human-computer interaction assisting device 100 may also be disposed separately from the executing device 200 and communicatively connected thereto via a wireless communication device, for example, a communication device such as Bluetooth, WIFI or the like, which is not specifically limited in the present embodiment. Besides, the human-computer interaction assisting device 100 may also be embedded in a remote control device of the executing device 200.

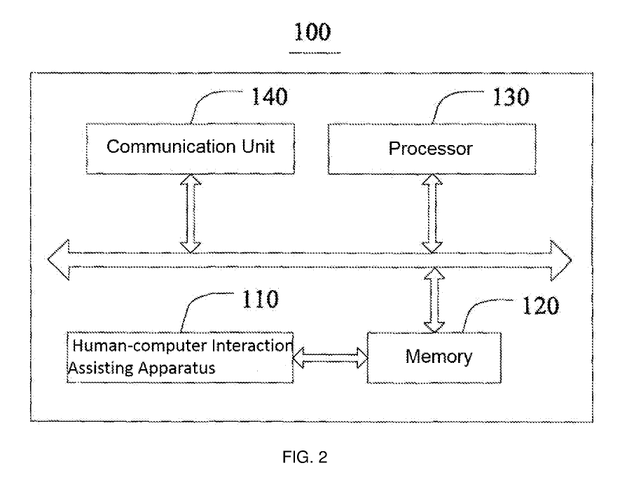

FIG. 2 shows a schematic block diagram of a human-computer interaction assisting device 100 shown in FIG. 1. The human-computer interaction assisting device 100 comprises a human-computer interaction assisting apparatus 110, a memory 120, a processor 130, and a communication unit 140.

The processor 130 is configured to execute an executable module, such as a computer program, stored in the memory 120. When the processor is executing a program, steps of a method as described in a first method embodiment are implemented, which specifically comprise: acquiring a first control instruction, wherein the first control instruction includes a voice control instruction and/or a text control instruction; parsing the first control instruction; generating a corresponding second control instruction based on the first control instruction, wherein the second control instruction is a preset control instruction that can be parsed by at least one of the executing devices; and searching for a target executing device corresponding to the first control instruction based on the first control instruction, and sending the second control instruction to the target executing device corresponding to the first control instruction.

The elements of the memory 120, the processor 130, and the communication unit 140 are electrically connected directly or indirectly to each other, to implement data transmission or interaction. For example, these elements may be electrically connected to each other via one or more communication buses or signal lines. The human-computer interaction assisting apparatus 110 includes at least one software functional module that may be stored in the memory 120 in the form of software or firmware, or solidified in an operating system (OS) of the human-computer interaction assisting device 100. The processor 130 is configured to execute an executable module stored in the memory 120, such as a software functional module, a computer program, and so on, included in the human-computer interaction assisting apparatus 110.

Here, the processor 130 may be an integrated circuit chip with a signal processing capability. In the implementation process, each of the steps of the abovementioned method may be carried out by an integrated logic circuit of hardware in the processor 130 or an instruction in a form of software. The abovementioned processor 130 may be a general-purpose processor, including a central processing unit (simply referred to as CPU), a network processor (simply referred to as NP), etc., or may also be a digital signal processor (simply referred to as DSP), an application specific integrated circuit (simply referred to as ASIC), a field-programmable gate array (simply referred to as FPGA) or other programmable logic device, discrete gate or transistor logic device, or discrete hardware component. The methods, steps, and logical block diagrams disclosed in the embodiments of the present application may be implemented or executed. The general-purpose processor may be a microprocessor, or the processor may also be any conventional processor or the like. The steps of the method disclosed in connection with the embodiment of the present application may be directly embodied to be carried out by a hardware decoding processor, or be carried out with a combination of hardware and software modules in the decoding processor. The software module may be located in a storage medium developed in the art such as a random access memory, a flash memory, a read only memory, a programmable read-only memory or an electrically erasable programmable memory, a register, or the like. The storage medium is located in the memory 120, and the processor 130 reads information in the memory 120 and carries out the steps of the abovementioned method in combination with its hardware.

The memory 120 may be, but is not limited to, a random access memory (RAM), a read only memory (ROM), a programmable read-only memory (PROM), an erasable programmable read-only memory (EPROM), an electric erasable programmable read-only memory (EEPROM), or the like. Here, the memory 120 is configured to store a program, and the processor 130 executes the program after receiving an execution instruction. The communication unit 140 is configured to establish a communication connection between the human-computer interaction assisting device 100 and the executing device 200 through the network 300, and is configured to send and receive data through the network 300.

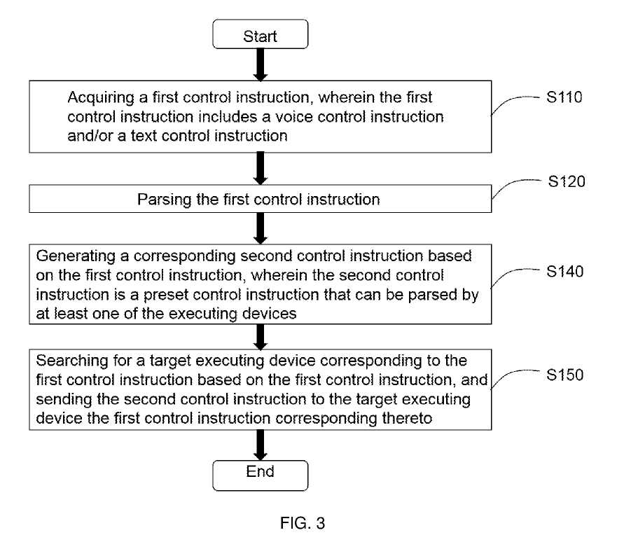

FIG. 3 shows a schematic flowchart of a method for assisting human-computer interaction which is applied to a human-computer interaction assisting device 100 shown in FIG. 1, the method comprises the following steps.

In step S110, the human-computer interaction assisting device 100 acquires a first control instruction, wherein the first control instruction includes a voice control instruction and/or a text control instruction.

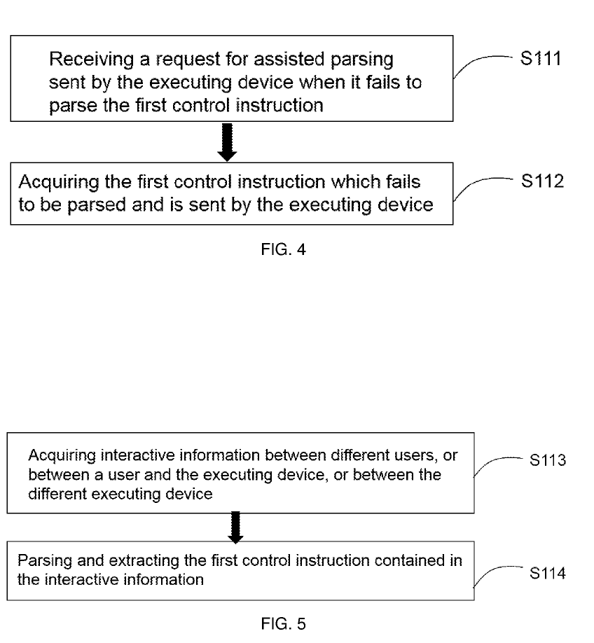

Specifically, referring to FIG. 4, in a first example of the present embodiment, the step S110 may comprise the following sub-steps:

in sub-step S111, a request, for assisted parsing sent by the executing device 200 when it fails to parse the first control instruction, is received.

In this example, the executing device 200 receives the first control instruction sent by a user, wherein the user may send the first control instruction by means of sending a voice instruction directly to the executing device 200, or sending a voice or text instruction to the executing device 200 through a user terminal. When the executing device 200 fails to parse the first control instruction, a request for assisted parsing is sent to the human-computer interaction assisting device 100.

If the first control instruction is a voice control instruction, in the present embodiment, a voice recognition chip and a voice input device may be embedded in the executing device 200, and the voice input device is configured to acquire a first control instruction sent by a user, and then the first control instruction is parsed by the embedded voice recognition chip. If the voice recognition chip fails to parse the first control instruction, the executing device 200 sends a request for assisted parsing to the human-computer interaction assisting device 100.

If the first control instruction is a text control instruction, in the present embodiment, the executing device 200 may contain a text input device and a text analysis device. The text input device is configured to acquire a first control instruction sent by a user. Then, the text analysis device is configured to parse the first control instruction. If the text analysis device fails to parse, the executing device 200 sends a request for assisted parsing to the human-computer interaction assisting device 100.

In sub-step S112, the first control instruction, which fails to be parsed and is sent by the executing device 200, is acquired.

After receiving the request for assisted parsing, the human-computer interaction assisting device 100 acquires, from the executing device 200, a first control instruction that fails to be parsed by the same.

Specifically, referring to FIG. 5, in a second example of the present embodiment, the step S110 may comprise the following sub-steps:

in sub-step S113, an interactive information of a communication group is acquired, wherein the interactive information includes: a voice information and/or a text information.

Optionally, the sub-step S113 includes: acquiring an interactive information between different users, or between a user and the executing device, or between the different executing devices.

In this example, an instant communication group is formed, through the network 300, between different users, and/or between a user and the executing device, and/or between the different executing devices, and the human-computer interaction assisting device 100 acquires an interactive information in this group. Here, the interactive information may be, but is not limited to, a voice information or a text information.

In sub-step S114, the first control instruction contained in the interactive information is parsed and extracted.

The human-computer interaction assisting device 100 sifts out and extracts, from the interactive information, the first control instruction contained therein. The interactive information contains various information that is not the first control instruction, on this basis, in the present embodiment, parsing and extraction rules may be preset, for example, a template of control instruction is preset, and then the interactive information is matched with the template of control instruction so as to extract the first control instruction. Alternatively, a plurality of keywords are preset, and then corresponding information is extracted from the interactive information in accordance with the keyword, and the extracted information is matched with the template of control instruction so as to extract the first control instruction.

In step S120, the first control instruction is parsed.

Specifically, in the present embodiment, the human-computer interaction assisting device 100 parses the first control instruction by a speech recognition model and/or a semantic analysis model. Here, the speech recognition model includes, but is not limited to, a hidden Markov (HMM) model and an artificial neural network model; the semantic analysis model includes, but is not limited to, a word-dependent (WD) model, a concept-dependent (CD) model, and a core-dependent (KD) model.

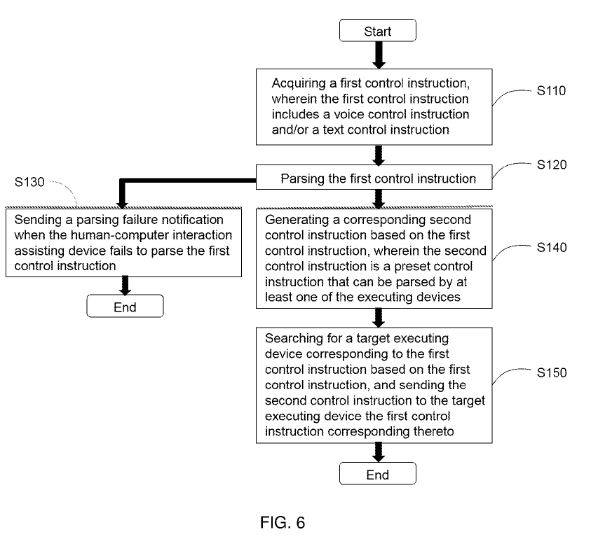

In the first example of the present embodiment, referring to FIG. 6, the method may further comprise step S130.

In step S130, a parsing failure notification is sent when the human-computer interaction assisting device 100 fails to parse the first control instruction.

When the human-computer interaction assisting device 100 fails to parse the first control instruction, a notification of the parsing failure is sent to the user or the user terminal, to prompt the user to re-issue an instruction.

In step S140, a corresponding second control instruction is generated based on the first control instruction, wherein the second control instruction is a preset control instruction that can be parsed by at least one of the executing devices 200.

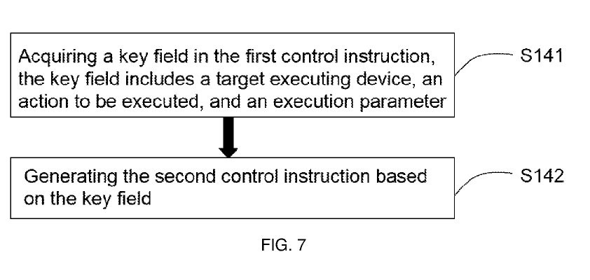

Specifically, referring to FIG. 7, the step S140 may comprise the following sub-steps.

In sub-step S141, a key field in the first control instruction is acquired, where the key field may include, but is not limited to, a target executing device, an action to be executed, and an execution parameter. Here, the action to be executed may be an action to be executed by the target executing device, for example, controlling an air conditioner to be turned on, and the execution parameter is an execution parameter for the target executing device, for example, controlling the air conditioner to be turned on and setting the temperature to 29° C., which are merely described here by way of example, and are not necessarily limited to the abovementioned operation and parameter.

In the present embodiment, the human-computer interaction assisting device 100 may set different kinds of extraction of key fields, for different types of executing devices connected thereto (e.g., smart home appliances, smart wearable devices, and remote monitoring cameras, etc.).

In sub-step S142, the second control instruction is generated based on the key field.

The human-computer interaction assisting device 100 generates the second control instruction, which matches the information in the key field, based on the type of a target executing device specified in the key field, using a corresponding instruction format.

In step S150, a search is performed for a target executing device 200 corresponding to the first control instruction based on the first control instruction, and the second control instruction is sent to the target executing device 200 the first control instruction corresponding thereto. Then, the second control instruction is sent to the target executing device 200.

As can be seen from the above description, the first control instruction contains a key field, which may include, but is not limited to, a target executing device, an action to be executed, and an execution parameter. On this basis, in the present embodiment, a search may be performed for a target executing device 200 corresponding to the first control instruction based on a field for indicating the target executing device in the key field.

Optionally, a target key field for representing identity information of the target executing device may be extracted from the first control instruction; and then, an executing device corresponding to the target key field is queried from data, and the executing device is used as the target executing device. For example, the target key field may be identification information for uniquely representing the identity information of the target executing device 200, such as ID information or the like.

The human-computer interaction assisting device 100 sends the parsed second control instruction to the executing device 200 based on the executing device 200 of the first control instruction.

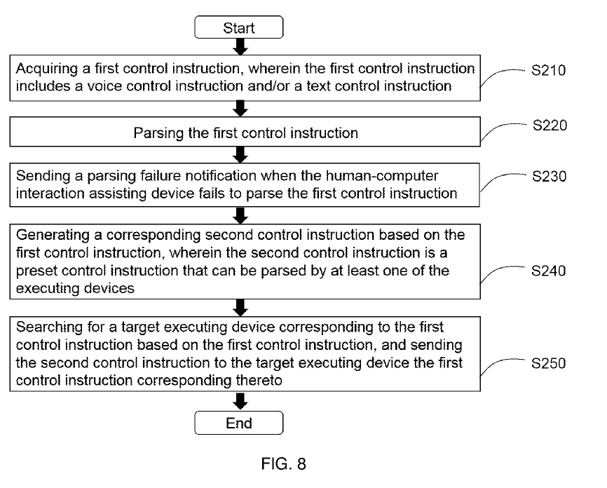

Referring to FIG. 8, the present embodiment further provides a method for assisting human-computer interaction, the method comprises the following steps.

In step S210, the human-computer interaction assisting device 100 acquires a first control instruction, wherein the first control instruction includes a voice control instruction or a text control instruction in a natural language form.

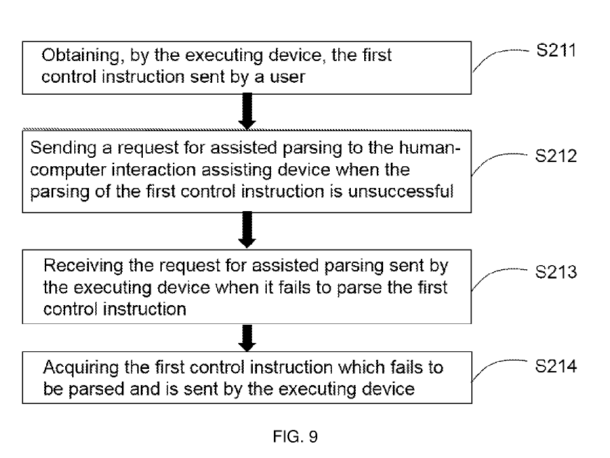

Referring to FIG. 9, in a third example of the present embodiment, the step S210 may comprise the following sub-steps:

in sub-step S211, the first control instruction sent by a user is obtained by the executing device 200.

In sub-step S212, a request for assisted parsing is sent to the human-computer interaction assisting device 100 when the parsing of the first control instruction is unsuccessful.

If the first control instruction is a voice control instruction, in the present embodiment, a voice recognition chip and a voice input device may be embedded in the executing device 200, and the voice input device is configured to acquire a first control instruction sent by a user, and then the first control instruction is parsed by the embedded voice recognition chip. If the voice recognition chip fails to parse the first control instruction, the executing device 200 sends a request for assisted parsing to the human-computer interaction assisting device 100.

If the first control instruction is a text control instruction, in the present embodiment, the executing device 200 may contain a text input device and a text analysis device. The text input device is configured to acquire a first control instruction sent by a user. Then, the text analysis device is configured to parse the first control instruction. If the text analysis device fails to parse, the executing device 200 sends a request for assisted parsing to the human-computer interaction assisting device 100.

In sub-step S213, the request for assisted parsing sent by the executing device 200 when it fails to parse the first control instruction is received.

In sub-step S214, the first control instruction which fails to be parsed and is sent by the executing device 200 is acquired.

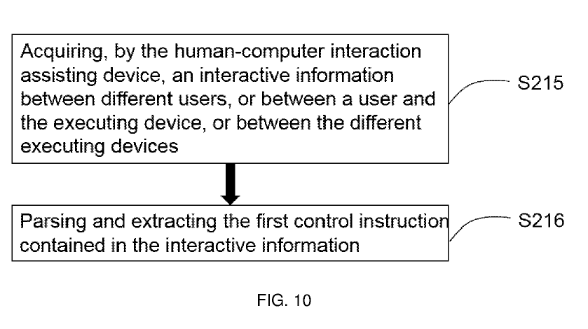

Referring to FIG. 10, in a fourth example of the present embodiment, the step S210 may comprise the following sub-steps:

sub-step S215 of acquiring, by the human-computer interaction assisting device 100, an interactive information of a communication group, wherein the interactive information includes a voice information and/or a text information, specifically includes: an interactive information between different users, or between a user and the executing device 200, or between the different executing devices 200; and

sub-step S216 of parsing and extracting the first control instruction contained in the interactive information.

In step S220, the first control instruction is parsed. The interactive information contains various information that is not the first control instruction. On this basis, in the present embodiment, parsing and extraction rules may be preset, for example, a template of control instruction is preset, and then the interactive information is matched with the template of control instruction so as to extract the first control instruction. Alternatively, a plurality of keywords are preset, and then corresponding information is extracted from the interactive information in accordance with the keyword, and the extracted information is matched with the template of control instruction so as to extract the first control instruction.

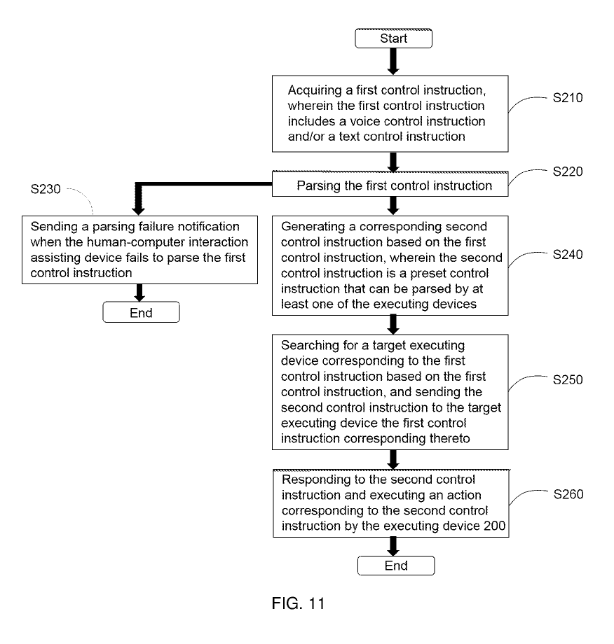

Referring to FIG. 11, in the third example of the present embodiment, the method further comprises step S230.

In step S230, a parsing failure notification is sent to the user and the executing device 200, when the human-computer interaction assisting device 100 fails to parse the first control instruction.

In step S240, a corresponding second control instruction is generated based on the first control instruction, wherein the second control instruction is a preset control instruction that can be parsed by at least one of the executing devices 200.

A key field in the first control instruction is acquired, where the key field may include, but is not limited to, a target executing device, an action to be executed, and an execution parameter. Here, the action to be executed may be an action to be executed by the target executing device, for example, controlling an air conditioner to be turned on, and the execution parameter is an execution parameter for the target executing device, for example, controlling the air conditioner to be turned on and setting the temperature to 29° C., which are merely described here by way of example, and are not necessarily limited to the abovementioned operation and parameter. The second control instruction is generated based on the key field. The human-computer interaction assisting device 100 generates the second control instruction, which matches the information in the key field, based on the type of a target executing device specified in the key field using a corresponding instruction format.

In step S250, a search is performed for a target executing device 200 corresponding to the first control instruction based on the first control instruction, and the second control instruction is sent to the target executing device 200 the first control instruction corresponding thereto.

As can be seen from the above description, the first control instruction contains a key field, which may include, but is not limited to, a target executing device, an action to be executed, and an execution parameter. On this basis, in the present embodiment, a search may be performed for a target executing device 200 corresponding to the first control instruction based on a field for indicating the target executing device in the key field. For example, the field may be identification information for uniquely representing the identity information of the target executing device 200, such as ID information or the like. Then, the second control instruction is sent to the target executing device 200.

In step S260, the executing device 200 responds to the second control instruction, and executes an action corresponding to the second control instruction.

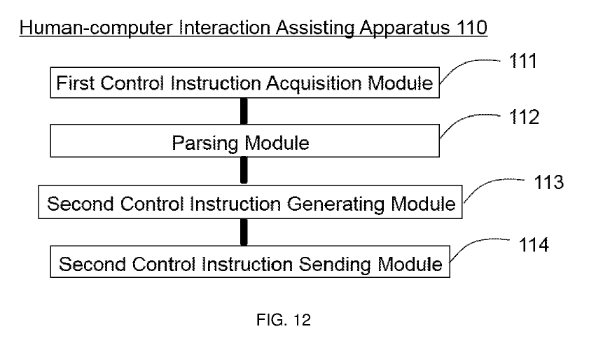

Referring to FIG. 12, the present embodiment further provides a human-computer interaction assisting apparatus 110, which is applied to a human-computer interaction assisting device 100 connected to at least one executing device 200, the apparatus comprises:

a first control instruction acquisition module 111, configured to acquire a first control instruction, wherein the first control instruction includes a voice control instruction and/or a text control instruction;

a parsing module 112, configured to parse the first control instruction;

a second control instruction generating module 113, configured to generate a corresponding second control instruction based on the first control instruction, wherein the second control instruction is a preset control instruction that can be parsed by at least one of the executing devices 200; and

a second control instruction sending module 114, configured to search for a target executing device 200 corresponding to the first control instruction based on the first control instruction, and to send the second control instruction to the target executing device 200 the first control instruction corresponding thereto.

In summary, in a method and apparatus for assisting human-computer interaction according to the present disclosure, the human-computer interaction assisting device 100, independent from the executing device 200, is disposed, such that the first control instruction that cannot be understood by the executing device 200 is parsed by the human-computer interaction assisting device 100, and a second control instruction that can be understood by the executing device 200 is generated and sent to the executing device 200. In this way, an effect of assisting the executing device 200 in parsing an instruction issued by a user is achieved without increasing investment in improving an information receiving interface or intelligence level of the executing device 200. The method of the present disclosure is simple and easily feasible, effectively saves the cost, and improves the user experience.

In the embodiments according to the present application, it should be understood that the disclosed apparatus and method may be implemented in other ways. The embodiments of the apparatus and method described above are merely illustrative in nature. For example, the flow charts and block diagrams in the figures illustrate implementable architectures, functionalities, and operations of systems, methods and computer program products according to multiple embodiments of the present application. In this regard, each block in the flow charts or block diagrams may represent a module, a program segment, or a portion of code, where the module, the program segment, or the portion of code contains one or more executable instructions for implementing specified logical function(s). It should also be noted that in some alternative implementations, the functions shown in the blocks may occur out of the order shown in the figures. For example, two blocks shown in succession may, in fact, be executed substantially in parallel, or they may sometimes be executed in a reverse order, depending upon the functionality involved. It will also be noted that each block of the block diagrams and/or flow charts, and combinations of blocks in the block diagrams and/or flow charts, may be implemented by special purpose hardware-based systems that execute the specified functions or actions, or by a combination of special purpose hardware and computer instructions.

In addition, the individual functional modules in the embodiments of the present application may be integrated together to form an independent part, or each module may be stand-alone, or two or more of the modules may be integrated to form an independent part.

If implemented in the form of a software functional module and sold or used as an independent product, the functions may be stored in a computer-readable storage medium. Based on such understanding, the technical solution of the present application essentially, or the part thereof contributing to the prior art, or a part of the technical solution may be embodied in the form of a software product. The computer software product is stored in a storage medium, and includes a number of instructions for causing an electronic device (which may be a personal computer, a server, a network device, or the like) to execute all or some of the steps of the methods described in the various embodiments of the present application.

It should be noted that in this text, the terms “comprise”, “include”, or any variations thereof are intended to cover non-exclusive inclusions, such that a process, method, article, or device that comprises a list of elements not only comprises those elements, but also comprises other elements not expressly listed or also comprises elements inherent to such process, method, article, or device. Without more restrictions, an element defined with the wording “comprising a . . . ” does not exclude the presence of additional identical elements in the process, method, article or device comprising said element.

It is obvious to those skilled in the art that the present application is not limited to the details of the foregoing exemplary embodiments, and the present application can be implemented in other specific forms without departing from the spirit or essential features of the present application. Therefore, from any point of view, the embodiments are to be considered as illustrative and not restrictive, and the scope of the present application is defined by the appended claims rather than by the above description, therefore all the changes falling within the meaning and scope of equivalent elements of the claims are intended to be included in the present application. Any reference numerals in the claims should not be considered as limiting the claim involved.

### INDUSTRIAL APPLICABILITY

In a method and apparatus for assisting human-computer interaction according to the embodiments of the present application, a human-computer interaction assisting device independent of an executing device is disposed, such that the first control instruction that cannot be understood by the executing device is parsed by the human-computer interaction assisting device, and a second control instruction that can be understood by the executing device is generated and sent to the executing device. In this way, an effect of assisting the executing device in parsing an instruction issued by a user is achieved without an additional investment in improving an information receiving interface or intelligence level of the executing device, the cost is effectively saved, and the user experience is improved.

1. A method for assisting human-computer interaction, which is applicable to a human-computer interaction assisting device connected to an executing device, wherein the method comprises:
acquiring a first control instruction, wherein the first control instruction comprises a voice control instruction and/or a text control instruction;
parsing the first control instruction;
generating a corresponding second control instruction based on the first control instruction, wherein the second control instruction is a preset control instruction that can be parsed by at least one of the executing devices;
searching for a target executing device corresponding to the first control instruction based on the first control instruction, and sending the second control instruction to the target executing device the first control instruction corresponding thereto.

2. The method for assisting human-computer interaction according to claim 1, wherein the step of acquiring a first control instruction comprises:
receiving a request for assisted parsing sent by the executing device when the executing device fails to parse the first control instruction; and
acquiring the first control instruction which is fail to be parsed and is sent by the executing device.

3. The method for assisting human-computer interaction according to claim 2, wherein the method further comprises:
sending a parsing failure notification when the human-computer interaction assisting device fails to parse the first control instruction.

4. The method for assisting human-computer interaction according to claim 2, wherein the request for assisted parsing is a request for assisted parsing sent to the human-computer interaction assisting device by the executing device when the executing device fails to parse a first control instruction sent by a user.

5. The method for assisting human-computer interaction according to claim 1, wherein the step of acquiring a first control instruction comprises:
acquiring an interactive information of a communication group, wherein the interactive information comprises a voice information and/or a text information; and
parsing and extracting the first control instruction contained in the interactive information.

6. The method for assisting human-computer interaction according to claim 5, wherein the parsing and extracting the first control instruction contained in the interactive information comprises:
obtaining a plurality of preset keywords; and
extracting corresponding information from the interactive information in accordance with the keywords, and matching the extracted information with a template of control instruction so as to extract the first control instruction.

7. The method for assisting human-computer interaction according to claim 1, wherein the step of acquiring an interaction information of a communication group comprises:
acquiring an interactive information between different users, or between a user and the executing device, or between the different executing devices.

8. The method for assisting human-computer interaction according to claim 1, wherein the step of generating a corresponding second control instruction based on the first control instruction comprises:
acquiring a key field in the first control instruction, wherein the key field comprises at least one of: a target executing device, an action to be executed, and an execution parameter; and
generating the second control instruction based on the key field.

9. The method for assisting human-computer interaction according to claim 8, wherein the generating the second control instruction based on the key field comprises:
generating the second control instruction, which matches information in the key field, based on the type of a target executing device specified in the key field and by using a corresponding instruction format.

10. The method for assisting human-computer interaction according to claim 8, wherein the human-computer interaction assisting device is able to set different types of extraction of key fields for different types of executing devices connected thereto.

11. The method for assisting human-computer interaction according to claim 1, wherein the first control instruction contains a key field configured to indicate a target executing device; and
the searching for a target executing device corresponding to the first control instruction based on the first control instruction comprises:
searching for a target executing device corresponding to the first control instruction based on the key field in the first control instruction.

12. The method for assisting human-computer interaction according to claim 11, wherein the key field comprises at least one of: a target executing device, an action to be executed, and an execution parameter; and
the searching for a target executing device corresponding to the first control instruction based on the key field in the first control instruction comprises:
extracting from the first control instruction a target key field for representing identity information of the target executing device, and
querying from data an executing device corresponding to the target key field, with the executing device used as the target executing device.

13. The method for assisting human-computer interaction according to claim 1, wherein the first control instruction is a voice control instruction; and
the parsing of the first control instruction comprises:
parsing the first control instruction by a speech recognition model.

14. The method for assisting human-computer interaction according to claim 1, wherein the first control instruction is a text control instruction; and
the parsing of the first control instruction comprises:
parsing the first control instruction by a semantic analysis model.

15. A computer-readable medium having a processor-executable non-volatile program code, wherein the program code causes the processor to execute the method according to claim 1.
